(19) United States
(12) Patent Application Publication
(10) Pub. No.: US 2007/0152066 A1
(43) Pub. Date: Jul. 5, 2007

(54) Combination transaction card and informative book

(76) Inventors: Charles Russ Colby, Marina del Rey, CA (US); Paul Curtis Hynek, Los Angeles, CA (US); David Alexander Gray, Phoenix, AZ (US)

Correspondence Address: Charles "Russ" Colby, 14003 Palawan Way #111, Marina del Rey, CA, 90292, US

(21) Appl. No.: 11/324,838

(22) Filed: Jan. 3, 2006

(51) Int. Cl. G06K 19/00; G06K 5/00

(52) U.S. Cl. 235/487; 235/380

(57) ABSTRACT

Combination transaction card and a credit card sized informative book with a multi page credit card sized book and a plastic coated top cover panel, the book consisting of a plurality of pages, and the plastic cover panel acting as a transaction card incorporating specific owner information such as a one of a kind number, a magnetic strip, bar code or an embedded micro-chip for the purpose of consumer purchasing transactions.

### CROSS REFERENCE TO RELATED APPLICATION

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of printable books and more specifically to combination transaction card and informative book. Small books such as address and phone books are well known. Additionally, customer transaction cards with customer identifying means such as magnetic strips, embedded micro chips, bar codes or unique numbers hidden behind scratch off panels are well known and are commonly used as credit cards, debit cards, phone cards or gift cards. There may be occasions where important information such as phone numbers, emergency information, or sales information would be valuable and convenient if they were directly associated with a customer transaction card so that the information would be at the user's disposal at the time of use of the card. Currently, no such combination exists.

### BRIEF SUMMARY OF THE INVENTION

The primary object of the invention is to provide a credit card sized informative book whose cover acts as a transaction card such as a credit card, phone card, gift card or debit card.

Another object of the invention is to provide an informative book whose cover has either a magnetic strip or bar code or custom number affixed to its front or back panel.

Another object of the invention is to provide an informative book whose cover has a micro-chip embedded within.

Another object of the invention is to provide an informative book whose cover is coated with tear resistant plastic.

A further object of the invention is to provide a credit card sized informative book whose inner pages are hingedly affixed at one side of said book.

Yet another object of the invention is to provide an alternate version of said informative book where the pages are assembled in an accordion style with the first page affixed to the front cover of the book.

Another object of the invention is to provide a credit card sized informative book that includes tear out coupons.

Another object of the invention is to provide a credit card sized informative book whose cover is a college identification card and whose pages include important information relating to the college.

Another object of the invention is to provide a credit card sized informative book whose cover is a state lottery card and whose pages include important state information.

Another object of the invention is to provide a credit sized informative book that includes a gift card cover and advertisements for products or services printed on the books pages.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed Combination transaction card and informative book comprising: a credit card sized book and a plastic coated book cover panel, said book consisting of a plurality of printable pages, and said plastic coated cover panel incorporating specific owner information embedded in an electronically readable format such as a magnetic strip, bar code, an embedded micro-chip or a scratch off panel revealing identifier numbers or letters.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a closed perspective view of the phone card version of the invention.

FIG. 2 is an open perspective view of the phone card version of the invention.

FIG. 3 is a closed perspective view of the credit card version of the invention.

FIG. 4 is an open perspective view of the credit card version of the invention.

FIG. 5 is a perspective view of an alternate accordion version of the invention.

FIG. 6 is a perspective view of an embodiment of the invention that includes tear out coupons and advertisements.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

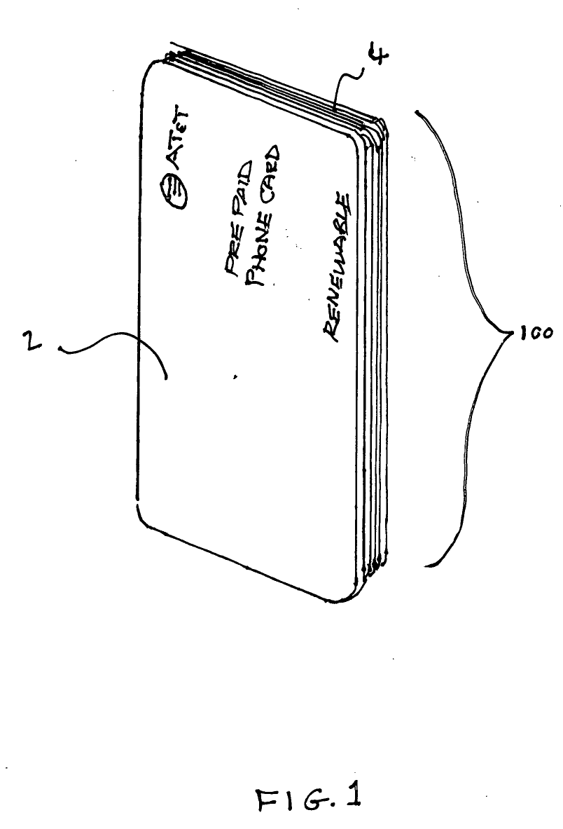

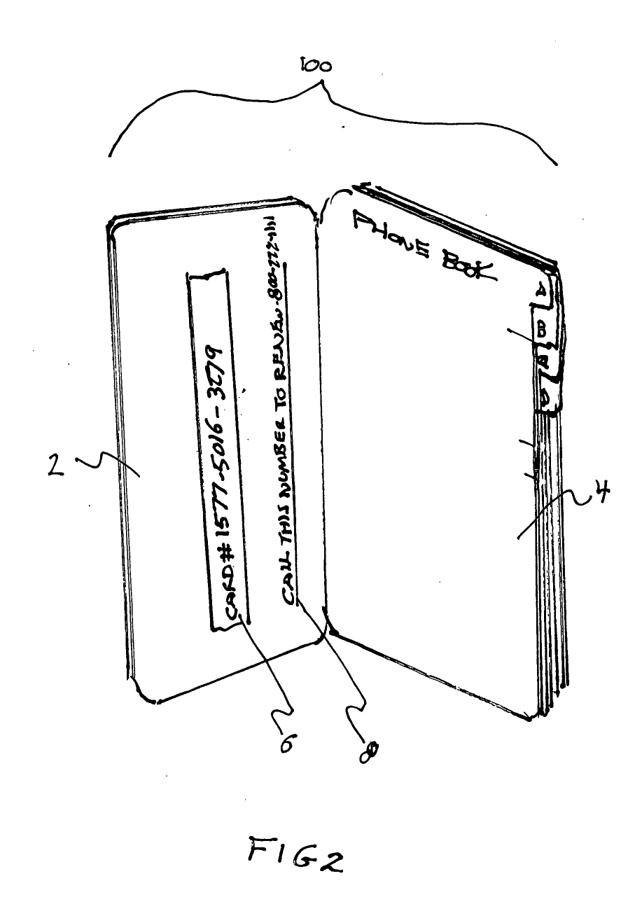

Referring now to FIG. 1 we see a perspective view of the closed phone card version of the invention 100. The invention consists of a plastic coated cover 2 and a phonebook portion 4. The plastic coated cover 2 is actually a pre paid phone card, also known as a calling card that can be used for paying for phone calls. FIG. 2 shows the phone card book 100 in the open position where the information needed for making a call 6 can be found. Because the phone book 4 is attached to the card 2, important phone numbers are always in close proximity to the phone card 2. Because the phone book 4 portion will become filled with important numbers, the user will be inclined to retain and/or renew the phone card and therefore maintain brand loyalty. The phone card, rather than being disposable, is designed to be renewed by calling a number 8 and requesting renewal using a credit card as a payment means.

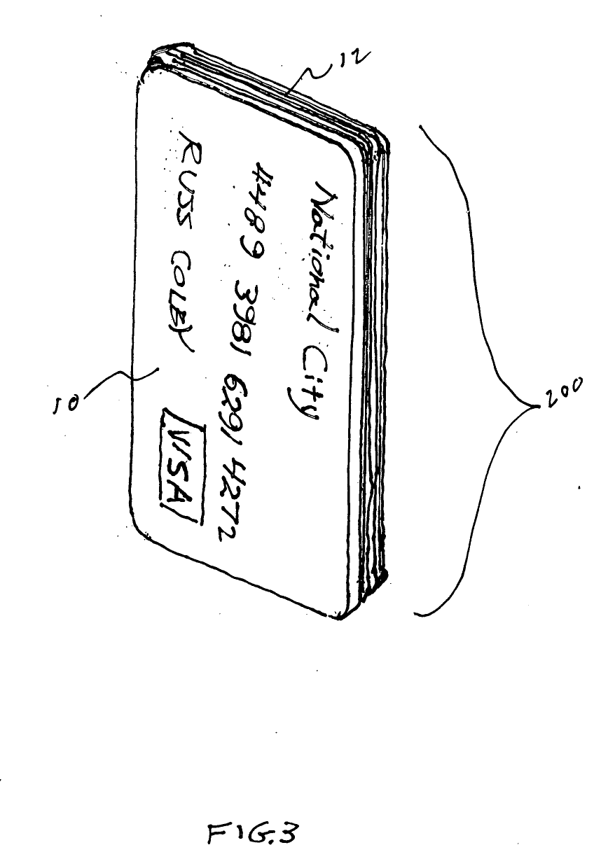

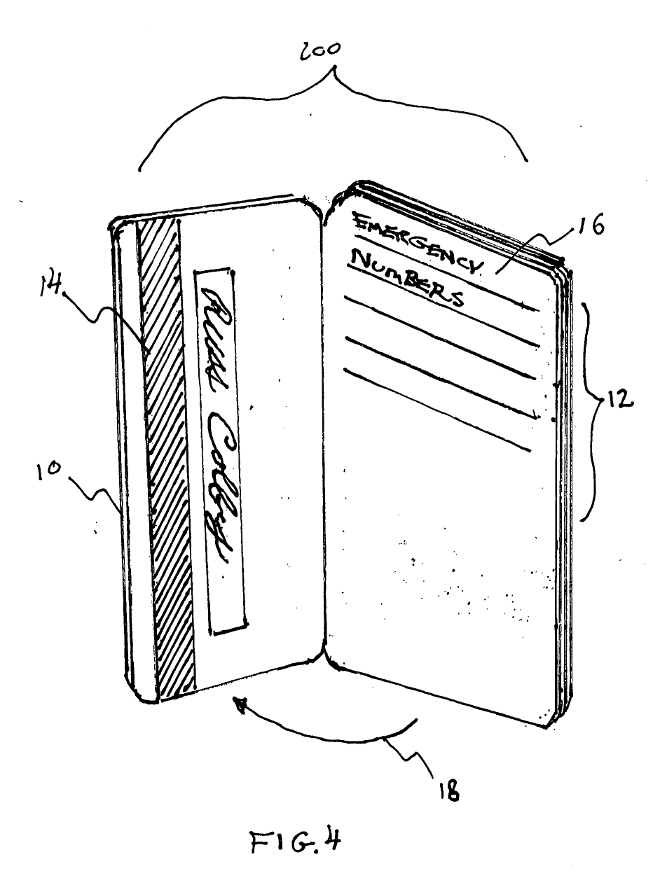

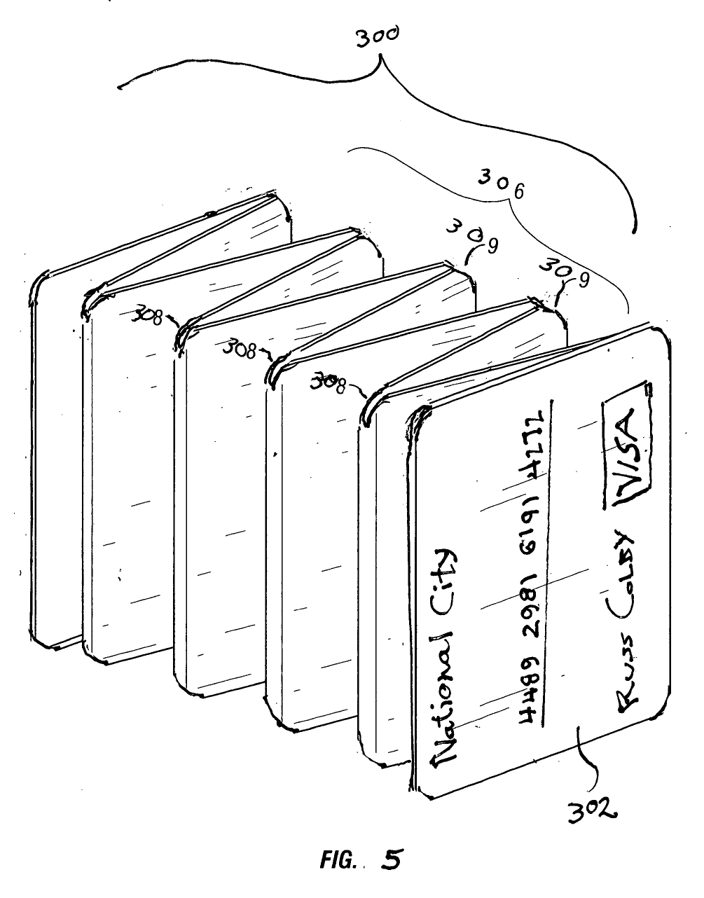

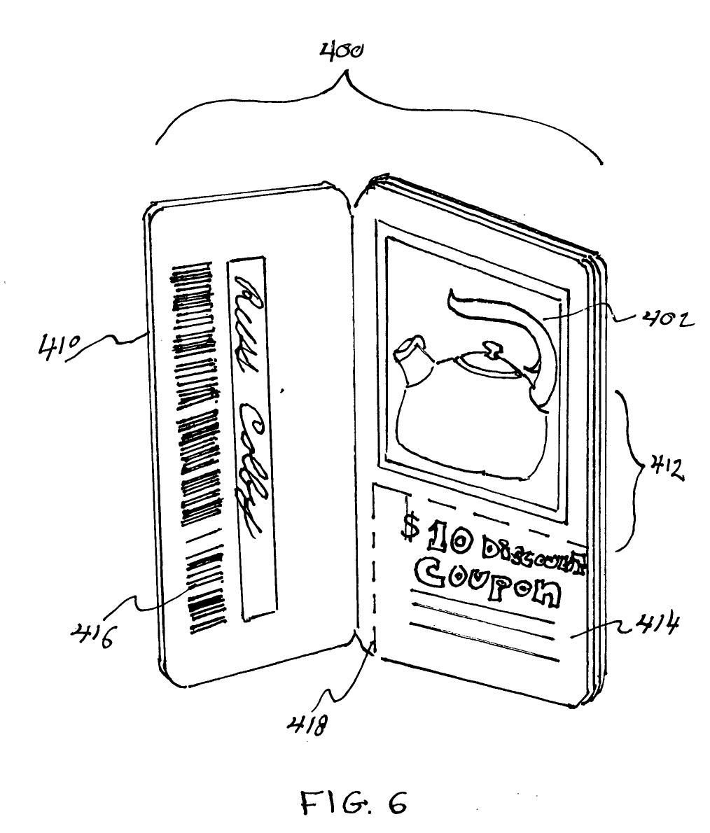

FIG. 3 shows a closed version of a credit card book 200. The cover of the book 10 is actually a credit card. The pages of the book 12 have the dimensions of the credit card. The pages 12 of the credit card book can be made of standard paper, however they can also be made of synthetic paper which has a polypropylene or polyester base. This type of synthetic material is preferable in that it is thin, water resistant and tear resistant. It is to be noted that the length and width dimensions credit cards, gift cards and phone cards have standardized to approximately three and three eighths of an inch by two and one eight of an inch. The pages 12 of the book are a similar dimension so that the book and attached card can fit in a standard wallet. Because of the thinness of the books pages 12, the entire card 10 and book pages 12 can be quite thin and fit easily into a person's wallet. The pages 12 can include catalog pages, personal medical history, emergency medical procedures, advertising, coupons, . Additionally, pages 12 can include perforated coupon portions that can be separated from the rest of pages 12. This feature is shown more clearly in FIG. 6 where a debit card 410 includes a custom bar 416 for an individual customer. the book page portion 412 includes a description of a product 402 and a coupon 414 that can be removed along perforation lines 418. FIG. 4 is an open version of the credit card book 200. The magnetic strip 14 of the credit card 10 can be easily seen. To use the credit card, the user can open 18 the hinged book cover 10 so that the credit card cover 10 is moved away from the pages 12 thereby enabling the user to slide the card into a standard magnetic strip reader. Alternately, the credit card 10 may have a micro-chip built into the body of the card. The card 10 may also be a debit card and can include a bar code or a series of custom numbers or letters so that each card 10 is one of a kind. The pages 12 portion of the credit card book can include important information such as emergency phone numbers 16 or other emergency procedures such as CPR. Because important emergency information is attached to this credit card, a person may choose this credit card over others that are offered thereby providing a marketing advantage for the credit card company offering the present invention 200. An alternate version of this book 200 is the use of a gift card as the cover instead of a credit card. A gift card is a credit card like device that is charged with a specific amount of money, for example $25.00, that allows the user to purchase any product or products up to the amount charged on the card. The card has either a magnetic strip or a bar code for reading the customer's unique number. In this case, the pages of the book 12 can be used to advertise products that are available at a particular store or chain of stores. One more use that is envisioned is as a quick reference information book for a cell phone. When a person buys a cell phone, he or she receives combination gift card and book. The book summarizes everything you need to know to operate the phone. Other embodiments of the invention 200 include having the cover 10 be an identification card such as a college identification Card. The pages portion 12 can include important college information. Still another embodiment of the invention can be where the cover 10 is a state lottery ticket and the pages 12 are important information relating to that state. One more use for the invention 200 can be to have the cover 10 act as a personal health insurance card and the internal pages 12 include important health related information and/or places for the owner of the card to fill out important personal medical history information. FIG. 5 is an alternate embodiment 300 of the present invention where the pages of the book 309 are folded 308 in an accordion fashion. This format has proven particularly effective for portraying an emergency sequence such as CPR or for showing a series of related products on one long page. Credit card 2 acts as the cover of the book and can be used in the same way as described above. FIG. 6 shows an embodiment of the invention 400 where the cover 410 is a gift card and includes a unique bar code 416 or other standard method for creating a custom transaction number. The pages portion 412 include images of products or services for sale 402 and coupons 414 that can be removed by tearing along perforated lines 418. In this way, a person can learn about products for sale and then use the money allocated on the gift card 410 as well as the discount coupon 414 for helping to pay for the sale.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Combination transaction card and informative book comprising:
a multi page credit card sized book;
a plastic coated top cover panel; and
said plastic cover panel incorporating specific owner information formatted in a standard way such as a magnetic strip, an embedded micro-chip, bar code or unique identifier numbers or letters for the purpose of consumer purchasing transactions.

2. Combination transaction card and informative book as claimed in claim 1 wherein said book pages and said cover are hingably fastened at one side of said book.

3. Combination transaction card and informative book as claimed in claim 1 wherein said cover and said book pages are folded accordion style.

4. Combination transaction card and informative book as claimed in claim 1 wherein said book can include pre-printed information that relates to the use of the said transaction card cover such as sales information for a gift card or health tips for a health insurance identification card.

5. Combination transaction card and informative book as claimed in claim 1 wherein said book pages are made of tear resistant, water resistant synthetic paper such as those that have a polypropylene or polyester base.

6. Combination transaction card and informative book as claimed in claim 1 wherein said book pages include perforations that allow the user to remove portions of said pages.

7. Combination transaction card and informative book as claimed in claim 1 wherein said transaction card can be a phone card, a credit card, a gift card, a lottery ticket, a school identification card, a heath plan identification card or an insurance card.
